(19) United States
(12) Patent Application Publication
(10) Pub. No.: US 2007/0216514 A1
(43) Pub. Date: Sep. 20, 2007

(54) Semiconductor device

(76) Inventors: Masaya Ohtsuka, Hyogo (JP); Atsushi Harikai, Hyogo (JP); Takashi Okazaki, Hyogo (JP)

Correspondence Address: COOPER & DUNHAM, LLP, 1185 AVENUE OF THE AMERICAS, NEW YORK, NY, 10036, US

(21) Appl. No.: 11/715,601

(22) Filed: Mar. 7, 2007

(30) Foreign Application Priority Data
Mar. 10, 2006 (JP) 2006-066800

(51) Int. Cl. H01H 37/76

(52) U.S. Cl. 337/404

(57) ABSTRACT

A semiconductor device includes a fuse element made of a metal wiring layer, the fuse element being fusable by laser irradiation; wherein the fuse element includes: a fusable metal part where the laser irradiation is applied so that the fusable metal part is cut; and a periphery metal part arranged around the fusable metal part and optically surrounding the fusable metal part.

### BACKGROUND OF THE INVENTION

1. Field of the Invention

The present invention generally relates to semiconductor devices, and more specifically, to a semiconductor device having a fuse element made of a metal wiring layer and which can be cut (melted) by laser irradiation. The fuse element, for example, can be used for redundancy or trimming.

2. Description of the Related Art

Recently, semiconductor devices such as sensor circuits have been and are frequently used not only for improving operational speeds but also in analog manners.

In an analog element requiring absolute characteristic precision such as a resistance element, a process called trimming may be applied wherein a fuse element made of poly-silicon, a metal wiring layer, or the like is cut so that a desirable resistance value is obtained. In addition, the fuse element is used for redundancy of DRAM (Dynamic Random Access Memory).

For example, Japanese Patent No. 3186744 describes, as the related art fuse element, a semiconductor device having a fuse element constituted of fuse element wiring layers formed in plural rows by keeping an interval in its wiring-width direction. The fuse element wiring layers in the individual rows are connected in series. According to this fuse element, even when the alignment of the laser beam is displaced, the fuse element wiring layers in any row can be positioned within a laser spot diameter, so that secure (assured) fusing can be done.

Japanese Laid-Open Patent Application Publication No. 10-135338 describes a fuse element cutting method wherein dummy metal is provided next to a fuse element to be cut and the fuse element is cut by effectively using a reflection light of a laser from the dummy metal.

In the meantime, in order to reduce an area where fuse elements are arranged, it is attempted to make the metal pitch narrow, namely make the laser spot diameter small. By making the laser spot diameter small, not only can an intermediate film be damaged when the laser is irradiated due to high energy densities but also a neighboring fuse element may be damaged due to reflection from a metal side surface.

FIG. 1 is a view showing a related art fuse element (FIG. 1(A) is a plan view and a FIG. 1(B) is a cross-sectional view taken along a line B-B.). As shown in FIG. 1, three fuse elements 23a through 23c are arranged and the fuse element 23b situated in the center is cut.

In order to make the fuse element pitch small and make the laser spot diameter small, the NA (numerical aperture) should be made large. As a result of this, the number of optical elements in an oblique direction becomes large so that the amount of light 15 reflected by a side surface of the fuse element 23b becomes large.

The reflection light 15 influences neighboring fuse elements 23a and 23c so that the fuse elements 23a and 23c may be cut in a worst case scenario. If the neighboring fuse elements 23a and 23c are cut, expected characteristics cannot be achieved so that characteristics of a product may be degraded.

Neither Japanese Patent No. 318674 nor Japanese Laid-Open Patent Application Publication No. 10-135338 discloses influence on the neighboring fuse elements of the reflection light of the laser irradiated on the fuse element.

### SUMMARY OF THE INVENTION

Accordingly, embodiments of the present invention may provide a novel and useful semiconductor device solving one or more of the problems discussed above.

More specifically, the embodiments of the present invention may provide a semiconductor device whereby bad influence on a neighboring fuse element caused by reflection light of a laser irradiated on a fuse element can be prevented.

One aspect of the present invention may be to provide a semiconductor device, including: a fuse element made of a metal wiring layer, the fuse element being fusable by laser irradiation; wherein the fuse element includes: a fusable metal part where the laser irradiation is applied so that the fusable metal part is cut; and a periphery metal part arranged around the fusable metal part and optically surrounding the fusable metal part.

Another aspect of the present invention may be to provide a semiconductor device, including a splitting resistance circuit configured to obtain a voltage output by voltage splitting using two or more resistance elements and to adjust the voltage output by cutting a fuse element; wherein the fuse element is made of a metal wiring layer and is fusable by laser irradiation; and the fuse element includes: a fusable metal part where laser irradiation is applied so that the fusable metal part is cut; and a periphery metal part arranged around the fusable metal part and optically surrounding the fusable metal part.

Other aspect of the present invention may be to provide a semiconductor device, including a splitting resistance circuit configured to split an input voltage and supply a split voltage; a standard voltage generation circuit configured to supply a standard voltage; and a voltage detection circuit having a comparator configured to compare the split voltage from the splitting resistance circuit and the standard voltage from the standard voltage generation circuit; wherein the splitting resistance circuit obtains a voltage output by voltage splitting using two or more resistance element and adjusts the voltage output by cutting a fuse element; the fuse element is made of metal wiring layer and fusable by laser irradiation; and the fuse element includes: a fusable metal part where laser irradiation is applied so that the fusable metal part is cut; and a periphery metal part arranged around the fusable metal part and optically surrounding the fusable metal part.

Other aspect of the present invention may be to provide a semiconductor device, including an output driver configured to control output of an input voltage; a splitting resistance circuit configured to split an output voltage and supply a split voltage; a standard voltage generation circuit configured to supply a standard voltage; and a constant voltage generation circuit having a comparator configured to compare the split voltage from the splitting resistance circuit and the standard voltage from the standard voltage generation circuit so as to control operation of the output driver based on the result of comparison; wherein the splitting resistance circuit obtains a voltage output by voltage splitting using two or more resistance element and adjusts the voltage output by cutting a fuse element; the fuse element is made of a metal wiring layer and is fusable by laser irradiation; and the fuse element includes: a fusable metal part where the laser irradiation is applied so that the fusable metal part is cut; and a periphery metal part arranged around the fusable metal part and optically surrounding the fusable metal part.

In the following explanation and claims, expression of “a periphery metal part optically surrounds a fusable metal part” means that the periphery metal part is arranged so that the reflection light of the laser irradiated on the fusable (can be melted by heat) metal part is not irradiated on a fusable metal part of another fuse element.

Other objects, features, and advantages of the present invention will be come more apparent from the following detailed description when read in conjunction with the accompanying drawings.

### BRIEF DESCRIPTION OF THE DRAWINGS

FIG. 1 is a view showing a related art fuse element (FIG. 1(A) is a plan view and a FIG. 1(B) is a cross-sectional view taken along a line B-B.);

FIG. 2 is a view showing a fuse element of a first embodiment of the present invention (FIG. 2(A) is a plan view and a FIG. 2(B) is a cross-sectional view taken along a line A-A.);

FIG. 3 is a plan view of the fuse element of the first embodiment of the present invention at the time of laser irradiation;

FIG. 4 is a plan view of a fuse element of a second embodiment of the present invention at the time of laser irradiation (FIG. 4(A) shows a case where there is no alignment displacement; FIG. 4(B) shows a case where the alignment is shifted in a Y axial direction; FIG. 4(C) shows a case where the alignment is shifted in an X axial direction; and FIG. 4(D) shows a case where the alignment is shifted in the X and Y axial directions.);

FIG. 5 is a plan view of a fuse element of a third embodiment of the present invention at the time of laser irradiation;

FIG. 6 is a plan view of a fuse element of a fourth embodiment of the present invention at the time of laser irradiation;

FIG. 7 is a plan view showing a fifth example of the present invention;

FIG. 8 is a plan view showing a fuse element used for evaluation;

FIG. 9 is a circuit diagram showing a circuit for evaluation and laser energy conditions;

FIG. 10 is a circuit diagram showing the circuit for evaluation and other laser energy conditions;

FIG. 11 is a circuit diagram showing an example of a semiconductor device having a constant voltage generation circuit as an analog circuit;

FIG. 12 is a circuit diagram showing an example of a semiconductor device having a voltage detection circuit as an analog circuit;

FIG. 13 is a circuit diagram showing an example of a splitting resistance circuit where the fuse element of the embodiment of the present invention is applied;

FIG. 14 is a view showing a lay-out example of the splitting resistance circuit, more specifically a lay-out example of a fuse element part; and

FIG. 15 is a view showing the lay-out example of the splitting resistance circuit, more specifically a lay-out example of a resistance element part.

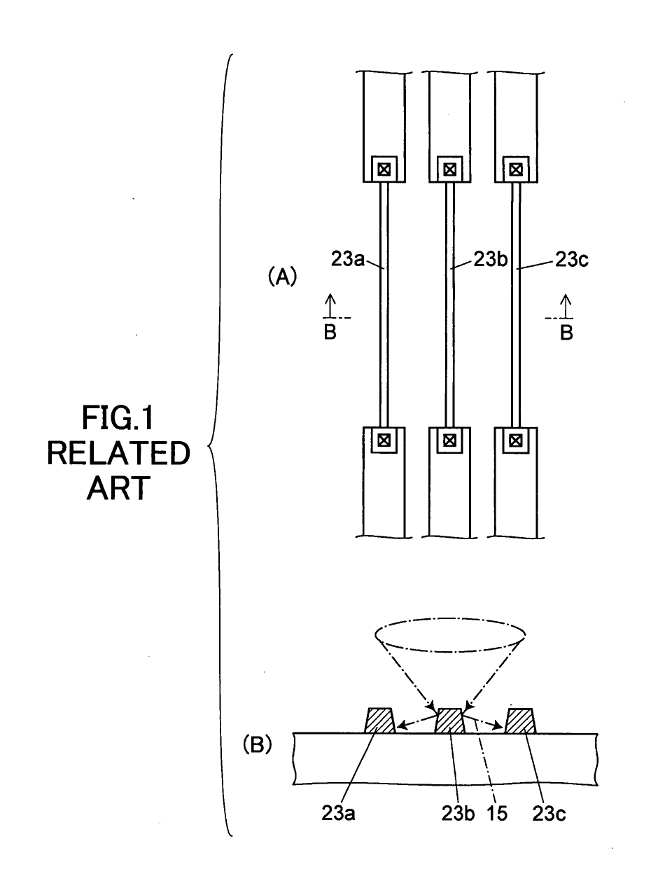

### DETAILED DESCRIPTION OF THE PREFERRED EMBODIMENTS

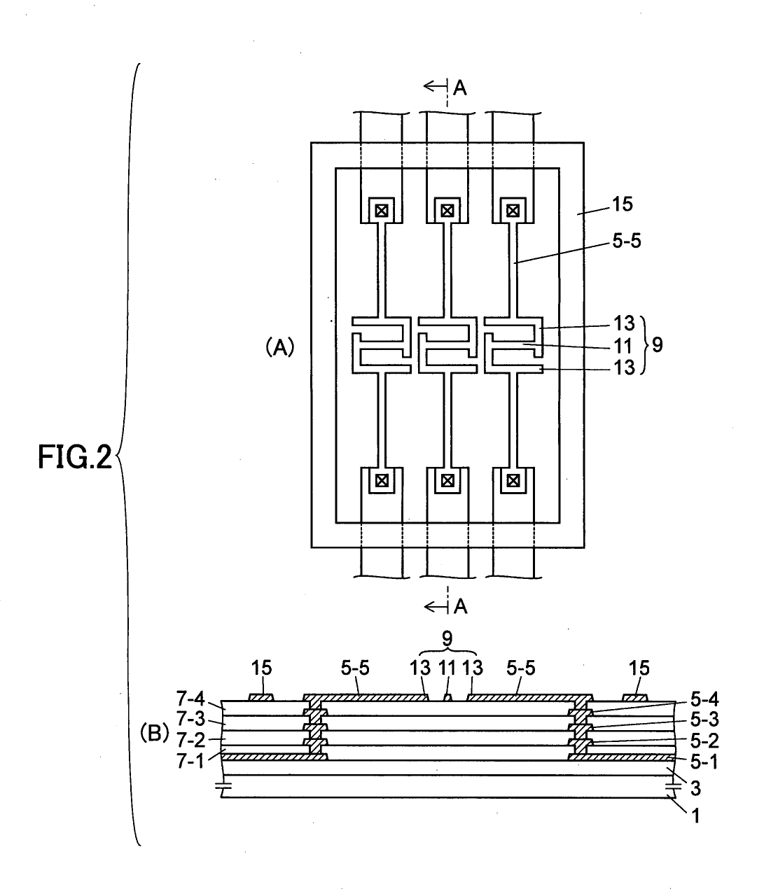

A description is given below, with reference to the FIG. 2 through FIG. 15 of embodiments of the present invention.

FIG. 2 is a view showing a fuse element of a first embodiment of the present invention (FIG. 2(A) is a plan view and FIG. 2(B) is a cross-sectional view taken along a line A-A.). In FIG. 2, illustration of a final protection film is omitted and illustration of an interlayer dielectric is omitted in FIG. 2(B).

As shown in FIG. 2(B), a poly-metal interlayer dielectric 3 is formed on a semiconductor substrate 1. A first metal wiring layer 5-1 through a fifth metal wiring layer 5-5 each layer made of AlCu having a thickness of approximately 600 nm are formed on the poly-metal interlayer dielectric 3 in this order. The metal wiring layers 5-1 through 5-5 have substantially trapezoidal-shaped cross sections.

A first inter-metal layer dielectric 7-1 through a fourth inter-metal layer dielectric 7-4 are formed interleaved between the first metal wiring layer 5-1 through the fourth metal wiring layer 5-5. A transistor element, a resistance element, a capacitive element, or the like is formed in an area, not shown in FIG. 2, of the semiconductor substrate 1.

A fuse element 9 which can be cut by laser irradiation and is made of the fifth metal wiring layer 5-5 is formed on the fourth inter-metal layer dielectric 7-4. The fuse element 9 includes a fusable metal part 11 where laser irradiation is applied so that the fusable metal part is cut, and a periphery metal part 13 arranged around the fusable metal part 11 and optically surrounding the fusable metal part 11.

The fusable metal part 11 is formed in a linear pattern. The periphery metal part 13 is formed with two L-shaped patterns arranged in a substantially rectangular shape.

Although there is no limitation of widths of the fusable metal part 11 and the periphery metal part 13, it is preferable that the fusable metal part 11 and the periphery metal part 13 have widths equal to or greater than 0.1 μm, more preferably equal to or greater than 0.3 μm. In this example, the fusable metal part 11 and the periphery metal part 13 have widths of 0.8 μm.

One end of the fusable metal part 11 is connected to an L-shaped pattern of the periphery metal part 13 and another end of the fusable metal part 11 is connected to another L-shaped pattern of the periphery metal part 13. Both L-shaped patterns of the periphery metal part 13 are connected to the first metal wiring layer 5-1 via the fifth metal wiring layer 5-5, a through hole plug, the fourth metal wiring layer 5-4, a through hole plug, the third metal wiring layer 5-3, a through hole plug, the second metal wiring layer 5-2, and a through hole plug.

Although there is no limitation of width of the first metal wiring layer 5-1, it is preferable that the first metal wiring layer 5-1 have width equal to or greater than 0.3 μm, more preferably equal to or greater than 0.5 μm. In this example, the first metal wiring layer 5-1 has a width of 1.5 μm.

A guard ring 15 made of the fifth metal wiring layer 5-5 is formed in the periphery of an area where the fuse elements 9 are arranged.

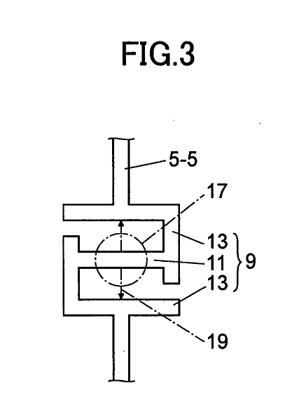

FIG. 3 is a plan view of the fuse element of the first embodiment of the present invention at the time of laser irradiation.

The spot diameter of a laser spot 17 indicated by a one dot line in FIG. 3 is, for example, approximately 2 μm. When the laser spot 17 is irradiated onto the fusable metal part 11 of the fuse element 9, as indicated by the one dot line in FIG. 3, the laser is reflected by a side surface of the fusable metal part 11 so that reflection light 19 is reflected onto the periphery metal part 13 arranged around the fusable metal part 11 so that leakage of the light outside the periphery metal part 13 is blocked.

Thus, by the periphery metal part 13, it is possible to prevent the reflection light 19 of the laser irradiated onto the fusable metal part 11 from being reflected onto the fusable metal part 11 of another fuse element 9. Hence, it is possible to avoid having the reflection light 19 of the laser irradiated on the fuse element 9 do damage to the neighboring fuse element 9.

In addition, even if the laser is irradiated onto the periphery metal part 13 due to the alignment displacement so that the laser light is reflected at the outside surface of the periphery metal part 13 to the neighboring fuse element 9 side, since the fusable metal part 11 of the neighboring fuse element 9 is also surrounded by a periphery metal part 13, it is possible to prevent the fusable metal part 11 of the neighboring fuse element 9 being cut in error.

Thus, it is possible to prevent the neighboring fuse element 9 being cut in error and therefore it is possible to achieve desirable properties of the product. By preventing cutting in error by the reflection light of the laser, it is possible to make the pitch of the fuse element 9 narrow.

In addition, since the reflection light 19 from the fusable metal part 11 can be reflected by the periphery metal part 13 to the fusable metal part 11, it is possible to securely fuse the fusable metal part 11.

Even if the periphery metal part 13 is cut by the reflection light 19 from the fusable metal part 11, since the fusable metal part 11 has the same electric potential as that of the periphery metal part 13, there is no problem.

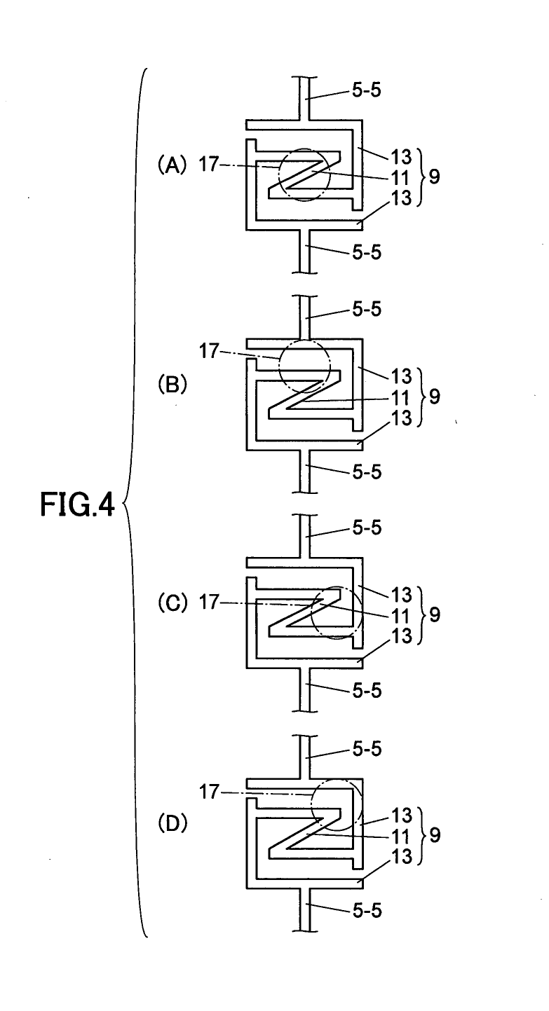

FIG. 4 is a plan view of a fuse element of a second embodiment of the present invention at the time of laser irradiation (FIG. 4(A) shows a case where there is no alignment displacement; FIG. 4(B) shows a case where the alignment is shifted in a Y axial direction (the vertical direction of the paper of the drawing); FIG. 4(C) shows a case where the alignment is shifted in an X axial direction (the horizontal direction of the paper of the drawing); and FIG. 4(D) shows a case where the alignment is shifted in the X and Y axial directions.).

In this embodiment, the fusable metal part 11 has a Z-shaped configuration. Since the fusable metal part 11 has the Z-shaped configuration, as shown in FIG. 4(B) through FIG. 4(D), even if the alignment displacement is generated, it is possible to securely fuse a part of the fusable metal part 11. In addition, as compared to the fusable metal part 11 having a linear-shaped configuration, since an area of the laser spot 17 irradiated on the semiconductor substrate 1, the insulation layers 3 and 7-1 through 7-4 at a lower layer side of the fusable metal part 11 can be made small, it is possible to reduce damage to the lower layer side of the fusable metal part 11.

FIG. 5 is a plan view of a fuse element of a third embodiment of the present invention at the time of laser irradiation.

In an example shown in FIG. 5(A), the fusable metal part 11 has an H-shaped configuration. In this example as compared to the case where the fusable metal part 11 has a linear-shaped configuration, since the area of the laser spot 17 irradiated on the semiconductor substrate 1, the insulation layers 3 and 7-1 through 7-4 at a lower layer side of the fusable metal part 11 can be made small, it is possible to reduce damage to the lower layer side of the fusable metal part 11.

In an example shown in FIG. 5(B), the direction of the fusable metal part 11 shown in FIG. 2 is changed. In an example shown in FIG. 5(C), the fusable metal part 11 shown in FIG. 4 is turned over and further rotated 90 degrees. Thus, there is no limitation of the direction of the fusable metal part 11. The direction of the fusable metal part 11 shown in FIG. 5(A) and having the H-shaped configuration can be changed.

In an example shown in FIG. 5(D), a concave part 11a is provided at the fusable metal part 11. In this example as compared to the case where the fusable metal part 11 has the linear-shaped configuration, since the area of the laser spot 17 irradiated at the lower layer side of the fusable metal part 11 can be made small, it is possible to reduce damage to the lower layer side of the fusable metal part 11. In addition, since the area of the laser spot 17 irradiated on the fusable metal part 11 including the concave part 11a can be made large, the fusable metal part 11 may be easily cut. Although three triangle-shaped concave parts are provided in the width direction of the fusable metal part 11, the present invention is not limited to this. The configuration or the number of the concave part provided at the fusable metal part 11 is optional.

Although the periphery metal part 13 is connected to the fusable metal part 11 in the above-discussed example, the periphery metal part 13 and the fusable metal part 11 may not be connected to each other.

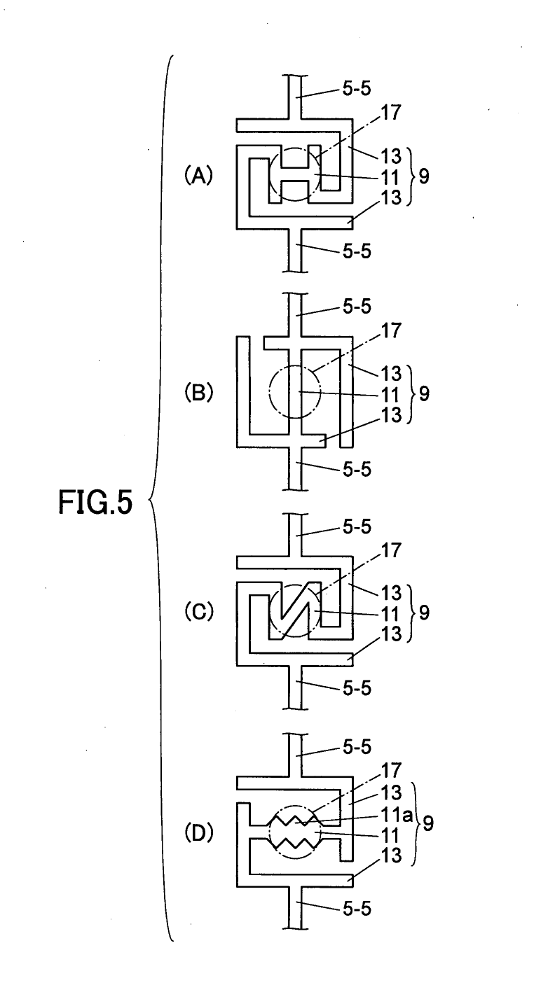

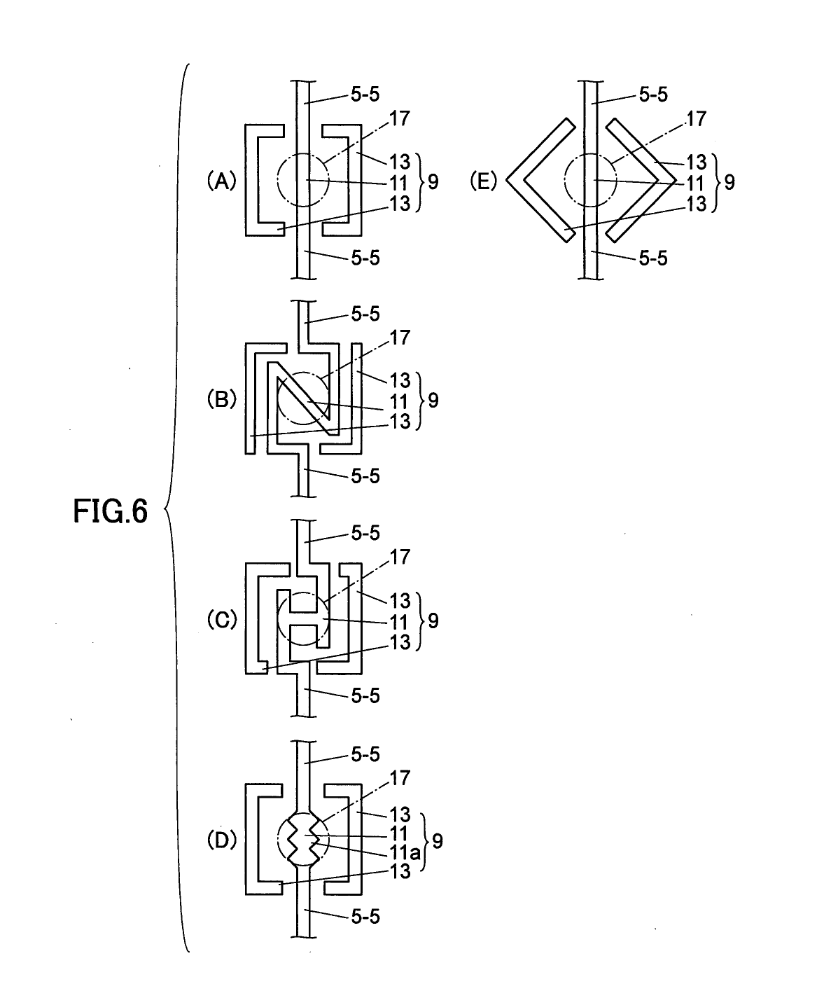

FIG. 6 is a plan view of a fuse element of a fourth embodiment of the present invention at the time of laser irradiation. In the examples shown in FIG. 6(A) and FIG. 6(E), the fusable metal parts 11 have linear shaped configurations. In the example shown in FIG. 6(B), the fusable metal part 11 has a Z-shaped configuration. In the example shown in FIG. 6(C) the fusable metal part 11 has an H-shaped configuration. In the example shown in FIG. 6(D), the fussable metal part 11 has a concave part 11a.

In these examples, the laser light is reflected by a side surface of the fusable metal part 11 so that reflection light is reflected onto the periphery metal part 13 arranged around the fusable metal part 11 so that leakage of the light outside the periphery metal part 13 is blocked.

Thus, by the periphery metal part 13, it is possible to prevent the reflection light of the laser irradiated on the fusable metal part 11 from being reflected onto the fusable metal part 11 of another fuse element 9. Hence, it is possible to avoid damage to the neighboring fuse element 9 caused by the reflection light of the laser irradiated on the fuse element 9.

In addition, even if the laser light is irradiated on the periphery metal part 13 due to alignment displacement so that the laser light is reflected at the outside surface of the periphery metal part 13 to the neighboring fuse element 9 side, since the fusable metal part 11 of the neighboring fuse element 9 is also surrounded by its own periphery metal part 13, it is possible to prevent the fusable metal part 11 of the neighboring fuse element 9 from being cut in error.

Thus, it is possible to prevent the neighboring fuse element 9 from being cut in error and therefore it is possible to achieve desirable properties of the product. By preventing cutting in error by the reflection light of the laser, it is possible to make the pitch of the fuse element 9 narrow.

In addition, since the reflection light from the fusable metal part 11 can be reflected by the periphery metal part 13 to the fusable metal part 11, it is possible to securely fuse the fusable metal part 11.

Even if the periphery metal part 13 is cut by the reflection light 19 from the fusable metal part 11, since the fusable metal part 11 and the periphery metal part 13 are not electrically connected to each other, there is no problem.

Even the fusable metal part and the periphery metal part are not connected to each other, the direction of the fusable metal part is optional.

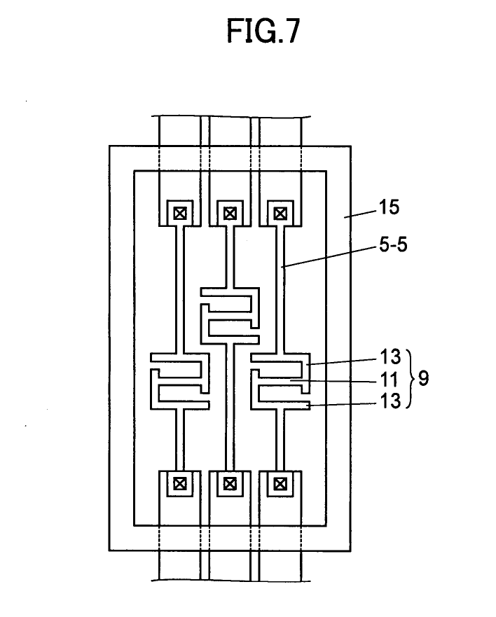

FIG. 7 is a plan view showing a fifth example of the present invention.

In this example, plural fuse elements 9 are arranged and the fusable metal part 11 and the periphery metal part 13 are arranged in a zigzag manner in the arrangement of the fuse elements 9.

According to this example, since a gap between neighboring fifth metal wiring layers (metal fuse wirings) 5-5 and 5-5 can be made narrow, the arrangement area of the fuse elements 9 can be made small and therefore the chip size can be made small.

The example where the fusable metal part and the periphery metal part are arranged in a zigzag manner in the arrangement of the plural fuse elements can be applied regardless of the configurations of the fusable metal part and the periphery metal part.

Although the fuse element is formed by the fifth metal wiring layer 5-5 in the above-mentioned example, the present invention is not limited to this. Any metal wiring layer can be used for forming the fuse element.

Next, the result of the evaluation of the laser energy margin of the fuse element forming the semiconductor device of the embodiment of the present invention is discussed with reference to FIG. 8. Here, FIG. 8 is a plan view showing a fuse element used for evaluation.

In the examples shown in FIG. 8(A) and FIG. 8(C), the fusable metal part of the fuse element have linear shaped configurations. In the example shown in FIG. 8(D), the fusable metal part of the fuse element 9 has an H-shaped configuration. In the example shown in FIG. 8(E), the fusable metal part of the fuse element 9 has a concave part.

The metal wiring layer of each of the fuse elements 9 has a thickness of 600 μm and a width of 0.9 μm. The external circumferential measurement of each of the fuse elements 9 whose fusable metal part 11 is (A) linear type (large) is 8 μm.

The external circumferential measurement of each of the fuse elements 9 whose fusable metal part 11 is (B) linear type (medium) is 7 μm. The external circumferential measurement of each of the fuse elements 9 whose fusable metal part 11 is (C) linear type (small) is 6 μm. The external circumferential measurement of each of the fuse elements 9 whose fusable metal part 11 is (D) H-shaped type is 8 μm. The external circumferential measurement of each of the fuse elements 9 whose fusable metal part 11 is (E) concave type is 8 μm.

The laser having a laser spot diameter of 4 μm and wave length (λ) is 1300 nm is used.

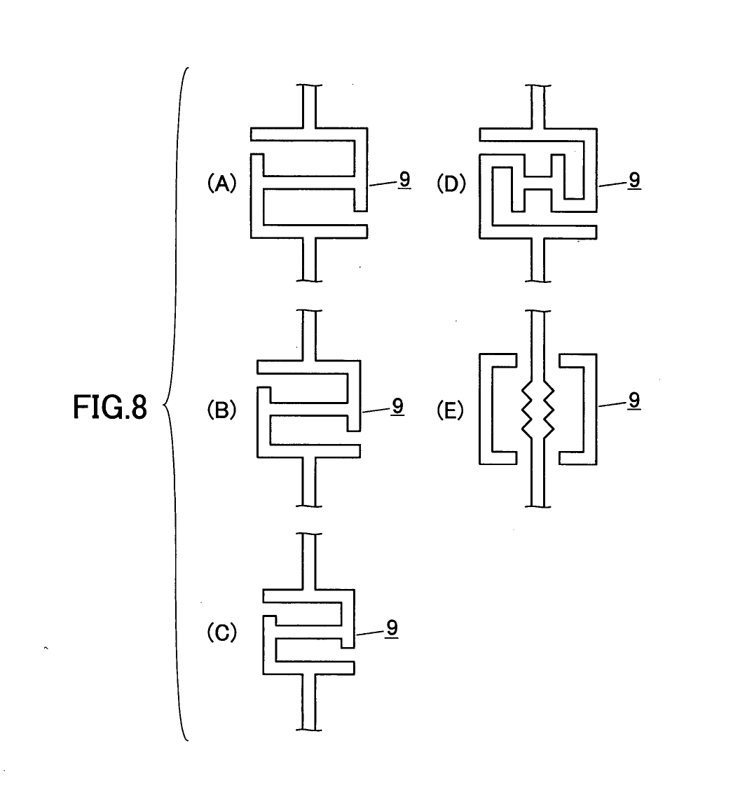

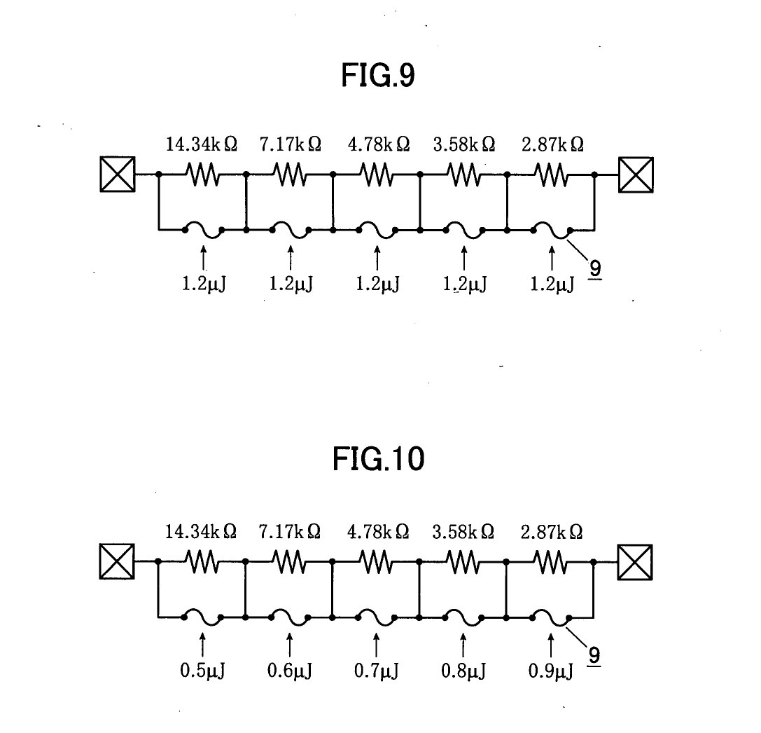

FIG. 9 is a circuit diagram showing a circuit for evaluation and laser energy conditions. FIG. 10 is a circuit diagram showing the circuit for evaluation and other laser energy conditions.

In the circuit used for evaluation, five resistance elements are connected in series between two electrode pads. The fuse elements 9 are each connected to a corresponding one of the resistance elements in parallel. The resistance values of the five resistance elements are different from each other.

In a case where all of the fuse elements 9 are cut, the path passing through all of the resistance elements is traced so that the resistance value between the electrode pads is approximately 33 kΩ.

In a case where not all the fuse elements 9 are cut, the path where the fuse elements 9 and the corresponding resistance elements are connected in parallel is traced so that the resistance value between the electrode pads is approximately 100Ω.

The evaluation is made for a case where the laser light having the same laser energy level (1.2 μJ) is irradiated on all of the fuse elements 9 (See FIG. 9) and a case where the laser light having different laser energy levels is irradiated (See FIG. 10). The evaluation for the same laser light energy level is done twice. The result of the evaluation is shown in Table 1 below.

TABLE 1

| | | | 0.5 through 0.9 μJ | |
|---|---|---|---|---|
| Configuration | 1.2 μJ | | | Cutting |
| of Fuse | 1^{st} time | 2^{nd} time | | Energy |
| A: Linear (L) | 32884 Ω | 32906 Ω | 7022 Ω | 0.8 μJ |
| B: Linear (M) | 32841 Ω | 32906 Ω | 8123 Ω | 0.8 μJ |
| C: Linear (S) | 32873 Ω | 32916 Ω | 11140 Ω | 0.7 μJ |
| D: H-type | 32906 Ω | 33014 Ω | 18262 Ω | 0.6 μJ |
| E: Convex | 32841 Ω | 32841 Ω | 10670 Ω | 0.8 μJ |

It is found that in the case of “1.2 μJ” of Table 1, all the kinds of fuse elements provide a resistance value of approximately 33 kΩ. All of the fuse elements are cut.

In the evaluation having different laser light energy level (0.5 through 0.9 μJ), the resistance value is less than 33 kΩ. This is because uncut fuse elements 9 exist. It can be found, from the obtained resistance value, which fuse element is cut and which fuse element is not cut. The laser light energy (cutting energy) by which the fuse element can be cut is indicated at right columns in the column of “0.5 through 0.9 μJ”.

As a result of this, the fuse element having the (D) H-type fusable metal part can be cut by the lowest energy level and the energy margin is largest. Since the (D) H-type fusable metal part can be cut by 0.6 μJ, there is 0.6 μJ margin for the laser light energy of, for example, 1.2 μJ. Even if the laser light energy at the time of mass production is various, the fuse element can be surely cut.

The fuse element forming the semiconductor device of the embodiment of the present invention can be applied to a semiconductor device having an analog circuit, for example. An example of the semiconductor device having the analog circuit including the fuse element of the embodiment of the present invention is discussed.

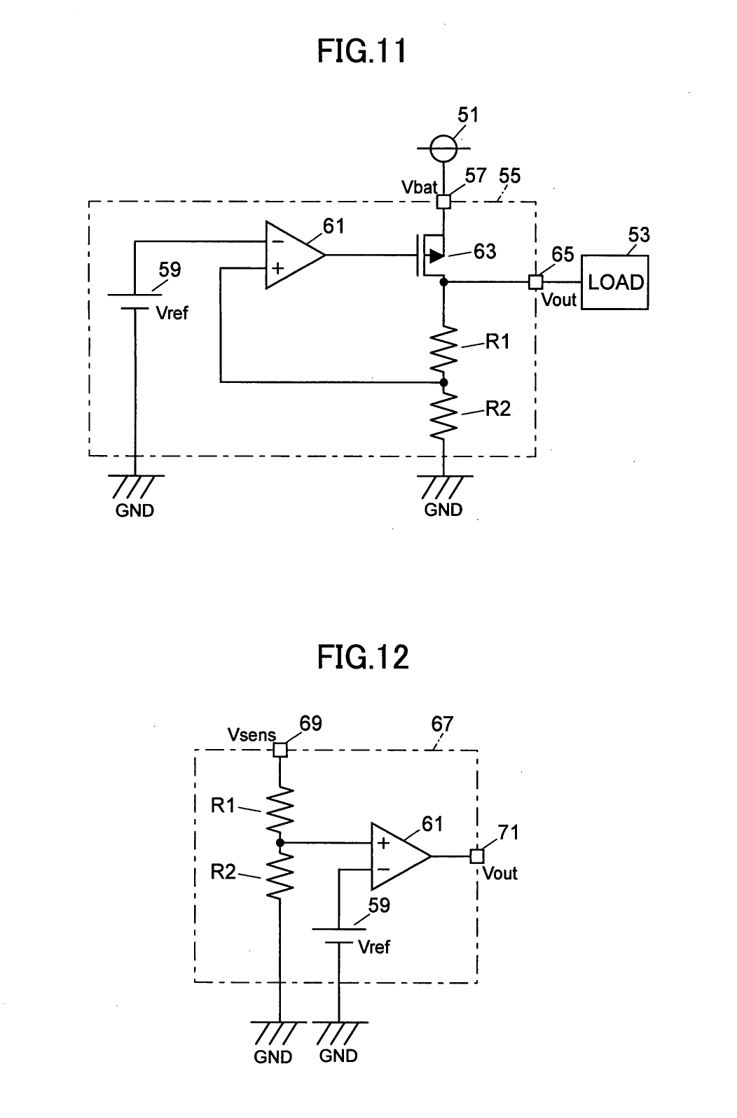

FIG. 11 is a circuit diagram showing an example of a semiconductor device having a constant voltage generation circuit as an analog circuit.

A constant voltage generation circuit 55 is provided so that electric power is stably supplied from a direct-current power supply to a load 53. The constant voltage generation circuit 55 includes an input terminal (Vbat) 57, a standard voltage generation circuit (Vref) 59, an operational amplifier (comparator) 61, a P channel MOS transistor (hereinafter “PMOS”) 63 forming an output driver, splitting resistances R1 and R2, and an output terminal (Vout) 65.

In the operational amplifier 61 of the constant voltage generation circuit 55, the output terminal is connected to the gate electrode of the PMOS 63. The standard voltage Vref is applied from the standard voltage generation circuit 59 to an inverting input terminal (−). A voltage formed by splitting the output voltage Vout by the resistance elements R1 and R2 is applied to the non-inverting input terminal (+). The split voltage of the resistance elements R1 and R2 is controlled so as to be equal to the standard voltage Vref.

FIG. 12 is a circuit diagram showing an example of a semiconductor device having a voltage detection circuit as an analog circuit.

In a voltage detection circuit 67, the standard voltage generation circuit 59 is connected to the inverting input terminal (−) of the operational amplifier 61 and the standard voltage Vref is applied to the standard voltage generation circuit 59. A voltage of a terminal to be measured from the input terminal (Vsens) 69 is split by the resistance elements R1 and R2 so as to be input to the non-inverting input terminal (+) of the operational amplifier 61. The output of the operational amplifier 61 is output outside via the output terminal (Vout) 71.

In the voltage detection circuit 67, when the voltage of the terminal to be measured is high and the voltage being split by the splitting resistances R1 and R2 is higher than the standard voltage Vref, the output of the operational amplifier 61 keeps an H level. When the voltage of the terminal to be measured is decreased and the voltage being split by the splitting resistances R1 and R2 is equal to or less than the standard voltage Vref, the output of the operational amplifier 61 becomes a L level.

Generally, in the constant voltage generation circuit shown in FIG. 11 or the voltage detection circuit shown in FIG. 12, the standard voltage Vref from the standard voltage generation circuit is changed due to unevenness of the manufacturing process. In order to respond to such change, a resistance element circuit (voltage splitting resistance circuit) wherein the resistance value can be controlled by cutting the fuse element is used as the splitting resistance element so that the resistance value of the splitting resistance element is controlled.

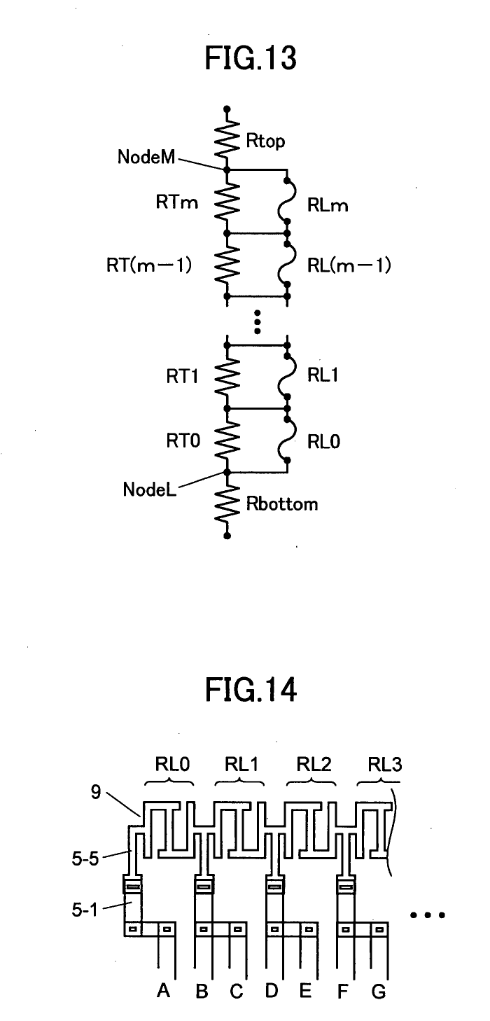

FIG. 13 is a circuit diagram showing an example of a splitting resistance circuit where the fuse element of the embodiment of the present invention is applied. FIG. 14 is a view showing a lay-out example of the splitting resistance circuit, more specifically a lay-out example of a fuse element part. FIG. 14 is a view showing the lay-out example of the splitting resistance circuit, more specifically a lay-out example of a resistance element part.

As shown in FIG. 13, a resistance element Rbottom, m+1 (m is a positive integer) resistance elements RT0, RT1, . . . , Rtm, and a resistance element Rtop are connected in series. Fuse elements RL0, RL1, . . . , RLm are connected, in parallel, to corresponding resistance elements RT0, RT1, . . . , Rtm.

As shown in FIG. 14, the fuse elements RL0, RL1, . . . , RLm are formed by the fuse elements 9 having the fusable metal part and the periphery metal part. The value of the resistance elements RT0, RT1, . . . , Rtm is increased in a binary number manner from a side of the resistance element Rbottom in order. In other words, the resistance value of the resistance element RTn is 2ⁿ times as many as a unit value that is a resistance value of the resistance element RTO.

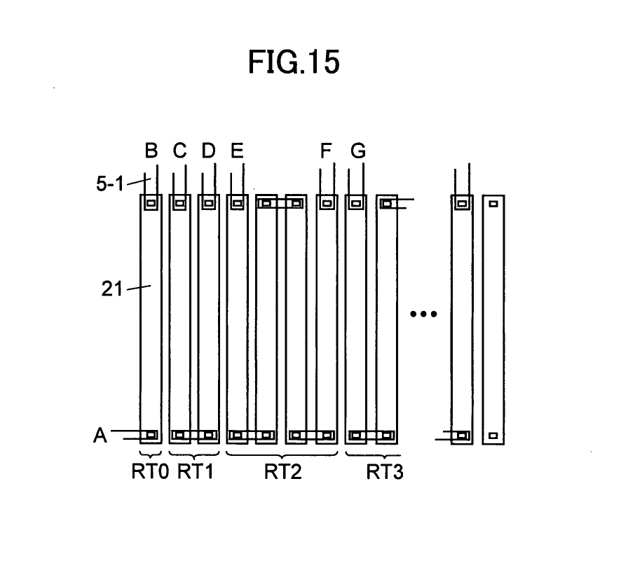

For example, as shown in FIG. 15, an SiCr thin film resistance body 21 made of SiCr thin film is used. The resistance element RT0, a unit resistance, is made of a single SiCr thin film resistance body 21. The resistance element RTn is formed by 2ⁿ SiCr thin film resistance bodies 21. The resistance element is not limited to the SiCr thin film resistance body but may be made of other metal or polysilicon film.

In FIG. 14 and FIG. 15, symbols A and A, symbols B and B, symbols C and C, symbols D and D, symbols E and E, symbols F and F, and symbols G and G are electrically connected by, for example, the first metal wiring layer 5-1, second through fourth metal wiring layers, and fifth metal wiring layer 5-5.

Thus, in the splitting resistance circuit where precision of the ratio of the resistance elements is critical, in order to improve the forming precision in the manufacturing process, the unit resistance elements formed by a fuse element and a pair of resistance elements are connected in series and arranged in a ladder structure.

In such a splitting resistance circuit, optional fuse elements RL0, RL1, . . . , and RLm are cut by the laser beam so that the desirable series resistance value can be obtained.

In the fuse element forming the semiconductor device of the embodiment of the present invention, it is possible to avoid the reflection light of the laser irradiated on the fuse element damaging on the neighboring fuse element. Since it is possible to prevent the neighboring fuse element from being cut in error, it is possible to improve the precision of the output voltage by controlling the splitting resistance circuit so as to provide a desirable property.

In a case where the splitting resistance circuit shown in FIG. 13 is applied to the splitting resistance elements R1 and R2 of the constant voltage generation circuit shown in FIG. 11, for example, an end of the resistance element Rbottom is connected to ground and an end of the resistance element Rtop is connected to a drain of the PMOS 63. In addition, a terminal NodeL between the resistance element Rbottom and RTO or a terminal NodeM between the resistance element Rtop and RTm is connected to the non-inverting terminal of the operational amplifier 61.

Since the precision of the output voltage of the splitting resistance elements R1 and R2 can be improved by the splitting resistance circuit where the fuse element of the embodiment of the present invention is applied, it is possible to improve the stability of the output voltage of the constant voltage generation circuit 55.

In addition, in a case where the splitting resistance elements R1 and R2 of the voltage detection circuit shown in FIG. 12 are applied to the splitting resistance circuit shown in FIG. 13, for example, the end of the resistance element Rbottom is connected to the ground and the end of the resistance element Rtop is connected to the input terminal 69. In addition, the terminal NodeL between the resistance element Rbottom and RTO or the terminal NodeM between the resistance element Rtop and RTm is connected to the non-inversing terminal of the operational amplifier 61.

Since the precision of the output voltage of the splitting resistance elements R1 and R2 can be improved by the splitting resistance circuit where the fuse element of the embodiment of the present invention is applied, it is possible to improve the precision of the voltage detection ability of the voltage detection circuit 67.

The present invention is not limited to these embodiments, but variations and modifications may be made without departing from the scope of the present invention.

The semiconductor device where the splitting resistance circuit where the fuse element of the embodiment of the present invention is applied is not limited to the semiconductor device having the constant voltage generation circuit and the semiconductor device having the voltage detection circuit. The present invention can be applied to any semiconductor device as long as the semiconductor device has the splitting resistance element.

Furthermore, the semiconductor device where the fuse element of the embodiment of the present invention is applied is not limited to the semiconductor device having the splitting resistance circuit; the present invention can be applied to any semiconductor device having the fuse element. For example, the present invention can be applied to a fuse element of the DRAM having the redundant circuit.

According to the above-discussed embodiments of the present invention, it is possible to provide a semiconductor device, including a fuse element made of a metal wiring layer, the fuse element being fusable by laser irradiation; wherein the fuse element includes: a fusable metal part where the laser irradiation is applied so that the fusable metal part is cut; and a periphery metal part arranged around the fusable metal part and optically surrounding the fusable metal part.

In the above-mentioned semiconductor device, the fusable metal part is where laser irradiation is applied so that the fusable metal part is cut, and the periphery metal part is arranged around the fusable metal part and optically surrounding the fusable metal part. Hence, by the periphery metal part, it is possible to prevent the reflection light of the laser irradiated on the fusable metal part from being reflected onto the fusable metal part of other fuse elements. Therefore, the reflection light of the laser irradiated on the fuse element damaging the neighboring fuse element can be avoided.

In addition, even if the laser is irradiated on the periphery metal part due to the alignment displacement so that the laser is reflected at the outside surface of the periphery metal part to the neighboring fuse element side, since the fusable metal part of the neighboring fuse element is also surrounded by the periphery metal part, it is possible to prevent the fusable metal part of the neighboring fuse element from being cut in error.

Thus, it is possible to prevent the neighboring fuse element from being cut in error and therefore it is possible to achieve desirable properties of the product. By preventing cutting in error by the reflection light of the laser, it is possible to make the pitch of the fuse element narrow.

In addition, since the reflection light from the fusable metal part can be reflected by the periphery metal part to the fusable metal part, it is possible to securely fuse the fusable metal part.

The fusable metal part may have a Z-shaped configuration.

According to the above-mentioned semiconductor device, even if the alignment displacement is generated, a part of the fusable metal part can be securely cut. Furthermore, as compared to a case where the fusable metal part is linear, since an area of the laser spot irradiated on the lower layer side of the fusable metal part can be made small, it is possible to reduce damage of the fusable metal part to the lower layer side.

The fusable metal part may have an H-shaped configuration.

According to the above-mentioned semiconductor device, as compared to a case where the fusable metal part is linear, since an area of the laser spot irradiated on the lower layer side of the fusable metal part can be made small, it is possible to reduce damage of the fusable metal part to the lower layer side.

The fusable metal part may have a concave part in a wiring width direction.

According to the above-mentioned semiconductor device, as compared to a case where the fusable metal part is linear, since an area of the laser spot irradiated on the lower layer side of the fusable metal part can be made small, damage of the fusable metal part to the lower layer side can be reduced. Furthermore, since the area of the laser irradiated on the fusable metal part can be made large, the fusable metal part can be easily cut.

The periphery metal part may not be connected to the fusable metal part. The periphery metal part may be connected to the fusable metal part.

By connecting the periphery metal part to the fusable metal part, the gap between the fusable metal part and the periphery metal part can be made small. Hence, leakage of the reflection light from the fusable metal part to the periphery metal part can be made small.

A plurality of the fuse elements may be arranged; and the fusable metal part and the periphery metal part may be arranged in a zigzag manner.

According to the above-mentioned semiconductor device, it is possible to make the gap between neighboring metal fuse wirings small. Hence, it is possible to make the arrangement area of the fuse element small so that the chip size can be made small.

According to the above-discussed embodiment of the present invention, it is possible to provide a semiconductor device, including: a splitting resistance circuit configured to obtain a voltage output by voltage splitting using two or more resistance elements and to adjust the voltage output by cutting a fuse element; wherein the fuse element is made of a metal wiring layer and is fusable by laser irradiation; and the fuse element includes: a fusable metal part where laser irradiation is applied so that the fusable metal part is cut; and a periphery metal part arranged around the fusable metal part and optically surrounding the fusable metal part.

It is possible to avoid bad influence of the reflection light of the laser irradiated on the fuse element on the neighboring fuse element in the fuse element forming the semiconductor device of the embodiment of the present invention. Since it is possible to prevent the neighboring fuse element from being cut in error, it is possible to control the splitting resistance circuit to have the desirable characteristics and therefore the precision of the output voltage can be improved.

According to the above-discussed embodiment of the present invention, it is possible to provide a semiconductor device, including: a splitting resistance circuit configured to split an input voltage and supply a split voltage; a standard voltage generation circuit configured to supply a standard voltage; and a voltage detection circuit having a comparator configured to compare the split voltage from the splitting resistance circuit and the standard voltage from the standard voltage generation circuit; wherein the splitting resistance circuit obtains a voltage output by voltage splitting using two or more resistance element and adjusts the voltage output by cutting a fuse element; the fuse element is made of metal wiring layer and fusable by laser irradiation; and the fuse element includes: a fusable metal part where laser irradiation is applied so that the fusable metal part is cut; and a periphery metal part arranged around the fusable metal part and optically surrounding the fusable metal part.

Since the precision of the output voltage can be improved by the splitting resistance circuit where the fuse element forming the semiconductor device of the embodiment of the present invention is applied, it is possible to improve the precision of the voltage detection ability of the voltage detection circuit.

According to the above-discussed embodiment of the present invention, it is possible to provide a semiconductor device, including: an output driver configured to control output of an input voltage; a splitting resistance circuit configured to split an output voltage and supply a split voltage; a standard voltage generation circuit configured to supply a standard voltage; and a constant voltage generation circuit having a comparator configured to compare the split voltage from the splitting resistance circuit and the standard voltage from the standard voltage generation circuit so as to control operation of the output driver based on the result of comparison; wherein the splitting resistance circuit obtains a voltage output by voltage splitting using two or more resistance element and adjusts the voltage output by cutting a fuse element; the fuse element is made of a metal wiring layer and is fusable by laser irradiation; and the fuse element includes: a fusable metal part where the laser irradiation is applied so that the fusable metal part is cut; and a periphery metal part arranged around the fusable metal part and optically surrounding the fusable metal part.

Since the precision of the output voltage can be improved by the splitting resistance circuit where the fuse element forming the semiconductor device of the embodiment of the present invention is applied, it is possible to stabilize the output voltage of the constant voltage generation circuit.

This patent application is based on Japanese Priority Patent Application No. 2006-66800 filed on Mar. 10, 2006, the entire contents of which are hereby incorporated by reference.

What is claimed is:

1. A semiconductor device, comprising:
a fuse element made of a metal wiring layer, the fuse element being fusable by laser irradiation;
wherein the fuse element includes:
a fusable metal part where the laser irradiation is applied so that the fusable metal part is cut; and
a periphery metal part arranged around the fusable metal part and optically surrounding the fusable metal part.

2. The semiconductor device as claimed in claim 1,
wherein the fusable metal part has a Z-shaped configuration.

3. The semiconductor device as claimed in claim 1,
wherein the fusable metal part has an H-shaped configuration.

4. The semiconductor device as claimed in claim 1,
wherein the fusable metal part has a concave part in a wiring width direction.

5. The semiconductor device as claimed in claim 1,
wherein the periphery metal part is not connected to the fusable metal part.

6. The semiconductor device as claimed in claim 1,
wherein the periphery metal part is connected to the fusable metal part.

7. The semiconductor device as claimed in claim 1,
wherein a plurality of the fuse elements are arranged; and
the fusable metal part and the periphery metal part are arranged in a zigzag manner.

8. A semiconductor device, comprising:
a splitting resistance circuit configured to obtain a voltage output by voltage splitting using two or more resistance elements and to adjust the voltage output by cutting a fuse element;
wherein the fuse element is made of a metal wiring layer and is fusable by laser irradiation; and
the fuse element includes:
a fusable metal part where laser irradiation is applied so that the fusable metal part is cut; and
a periphery metal part arranged around the fusable metal part and optically surrounding the fusable metal part.

9. A semiconductor device, comprising:
a splitting resistance circuit configured to split an input voltage and supply a split voltage;
a standard voltage generation circuit configured to supply a standard voltage; and
a voltage detection circuit having a comparator configured to compare the split voltage from the splitting resistance circuit and the standard voltage from the standard voltage generation circuit;
wherein the splitting resistance circuit obtains a voltage output by voltage splitting using two or more resistance element and adjusts the voltage output by cutting a fuse element;
the fuse element is made of metal wiring layer and fusable by laser irradiation; and
the fuse element includes:
a fusable metal part where laser irradiation is applied so that the fusable metal part is cut; and
a periphery metal part arranged around the fusable metal part and optically surrounding the fusable metal part.

10. A semiconductor device, comprising:
an output driver configured to control output of an input voltage;
a splitting resistance circuit configured to split an output voltage and supply a split voltage;
a standard voltage generation circuit configured to supply a standard voltage; and
a constant voltage generation circuit having a comparator configured to compare the split voltage from the splitting resistance circuit and the standard voltage from the standard voltage generation circuit so as to control operation of the output driver based on the result of comparison;
wherein the splitting resistance circuit obtains a voltage output by voltage splitting using two or more resistance element and adjusts the voltage output by cutting a fuse element;
the fuse element is made of a metal wiring layer and is fusable by laser irradiation; and
the fuse element includes:
a fusable metal part where the laser irradiation is applied so that the fusable metal part is cut; and
a periphery metal part arranged around the fusable metal part and optically surrounding the fusable metal part.
